(19) United States
(12) Patent Application Publication
(10) Pub. No.: US 2025/0140784 A1
(43) Pub. Date: May 1, 2025

(54) ELECTRODE PLATE, BATTERY CELL, AND ELECTRICAL DEVICE

(71) Applicant: Ningde Amperex Technology Limited, Ningde (CN)

(72) Inventor: Jiaxiao YAN, Ningde (CN)

(73) Assignee: Ningde Amperex Technology Limited, Ningde (CN)

(21) Appl. No.: 18/932,039

(22) Filed: Oct. 30, 2024

(30) Foreign Application Priority Data
Oct. 31, 2023 (CN) 202311439561.7

(51) Int. Cl. H01M 4/13; H01M 4/02; H01M 4/66

(52) U.S. Cl. CPC H01M 4/13; H01M 4/667; H01M 2004/021

(57) ABSTRACT

A current collector includes a support layer and a first conductive layer and a second conductive layer that are disposed on two sides of the support layer in a thickness direction of the current collector. The current collector is divided into a first blank foil section and a coated section disposed in sequence in a second direction. A first active material layer is located on the coated section and disposed on a surface of the first conductive layer, the surface being oriented away from the support layer. A second active material layer is located on the coated section and disposed on a surface of the second conductive layer, the surface being oriented away from the support layer. Along the thickness direction of the current collector, a part of a projection of the first active material layer does not coincide with a projection of the second active material layer.

### CROSS-REFERENCE TO THE RELATED APPLICATION

This application claims priority to the Chinese Patent Application Serial No. 202311439561.7, filed on Oct. 31, 2023, the content of which is incorporated herein by reference in its entirety.

### TECHNICAL FIELD

This application relates to the technical field of energy storage, and in particular, to an electrode plate, a battery cell, and an electrical device.

### BACKGROUND

An existing composite current collector is a three-layer sandwich structure, in which the central layer is a polymer layer and the outer layer is a metal layer. After the outer layer of the composite current collector is coated with the active material layer, the active material layer needs to be compacted by cold-pressing to form an electrode plate. A region, coated with the active material layer, of the composite current collector is referred to as a coated section, and the region uncoated with the active material layer is referred to as a blank foil section. An edge region, close to the blank foil section, of the coated section is typically coated with two active material layers. During the cold-pressing, because the elongation rate of the coated section is greater than that of the blank foil section, the cold-pressing force is applied downward along the thickness direction of the electrode plate during the cold-pressing. Because the thickness and elongation rate of the coated section are relatively large, the deformation of the coated section caused by the cold-pressing is greater than that of the blank foil section along a direction perpendicular to the thickness of the electrode plate. Consequently, the shear force borne by the edge region of the coated section is relatively large, and is prone to impair the structural strength at the junction between the coated section and the blank foil section, thereby resulting in relatively low structural strength and conductive performance of the electrode plate.

### SUMMARY

In view of the above situation, it is necessary to provide an electrode plate to improve structural strength and conductive performance.

An embodiment of this application provides an electrode plate. The electrode plate includes a current collector, a first active material layer, and a second active material layer. The current collector includes a support layer and a first conductive layer and a second conductive layer that are disposed on two sides of the support layer in a first direction respectively. The first direction is a thickness direction of the current collector. The current collector is divided into a first blank foil section and a coated section disposed in sequence in a second direction. The first blank foil section is configured to be connected to an electrode terminal, and the second direction is perpendicular to the first direction. The first active material layer is located on the coated section and disposed on a surface of the first conductive layer, the surface being oriented away from the support layer. The second active material layer is located on the coated section and disposed on a surface of the second conductive layer, the surface being oriented away from the support layer. Along the first direction, a part of a projection of the first active material layer does not coincide with a projection of the second active material layer.

In the electrode plate, along the first direction, a part of the projection of the first active material layer does not coincide with the projection of the second active material layer, so that only either the first active material layer or the second active material layer is disposed in the edge region, close to the first blank foil section, of the coated section; and/or, only either the first active material layer or the second active material layer is disposed in the edge region, away from the first blank foil section, of the coated section. In contrast to the conventional electrode plate in which the active material layer is disposed on both sides of the edge region of the coated section, this application can reduce the thickness of the electrode plate at a position corresponding to the edge region of the coated section, thereby alleviating the shear force borne by the edge region of the coated section during cold-pressing, reducing the risk that the structural strength and conductive performance of the current collector are impaired at the boundary of the coated section due to an excessive shear force, and in turn, improving the structural strength and conductive performance of the electrode plate.

In some embodiments of this application, the current collector further includes a second blank foil section in the second direction. The coated section is located between the first blank foil section and the second blank foil section. Along the second direction, the first active material layer includes a first end face and a second end face disposed opposite to each other. The first end face is closer to the first blank foil section than the second end face, and the second end face is closer to the second blank foil section than the first end face. Along the second direction, the second active material layer includes a third end face and a fourth end face disposed opposite to each other, the third end face is closer to the first blank foil section than the fourth end face, and the fourth end face is closer to the second blank foil section than the third end face. At least a part of the projection of the first end face does not overlap with the projection of the third end face in the first direction, so that only either the first active material layer or the second active material layer is disposed in the edge region, close to the first blank foil section, of the coated section; and/or, at least a part of the projection of the second end face in the first direction does not overlap with the projection of the fourth end face in the first direction, so that only either the first active material layer or the second active material layer is disposed in the edge region, close to the second blank foil section, of the coated section.

In some embodiments of this application, along the second direction, a width W₁ of the first blank foil section satisfies: 1 mm≤W₁≤5 mm, and a width W₂ of the second blank foil section satisfies: 1 mm≤W₂≤5 mm, so as to increase the connection strength between the second blank foil section and the electrode terminal, reduce the space waste caused by the first blank foil section or the second blank foil section, and increase the energy density of the electrode plate.

In some embodiments of this application, 1.8 mm≤W₁≤2.4 mm, and 1.8 mm≤W₂≤2.4 mm, so as to further increase the connection strength between the second blank foil section and the electrode terminal, reduce the space waste caused by the first blank foil section or the second blank foil section, and increase the energy density of the electrode plate.

In some embodiments of this application, along the second direction, a width L₁ of the first active material layer and a width L₂ of the second active material layer satisfy: L₁=(1±5%)L₂; and a distance S₁ between the first end face and the third end face as well as a distance S₂ between the second end face and the fourth end face satisfy: S₁=(1±5%)S₂, 0.1 mm≤S₁≤1 mm, and 0.1 mm≤S₂≤1 mm. When S₁ or S₂ is excessively small (less than 0.1 mm), the end portions of the first active material layer and the second active material layer may be flush with each other due to the fluctuation of the processing tolerance, thereby being unable to reduce the thickness of the electrode plate at a position corresponding to the edge region of the coated section, being unfavorable to alleviating the shear force borne by the edge region of the coated section during cold-pressing, and impairing the structural strength and conductive performance of the electrode plate. When S₁ or S₂ is excessively large (greater than 1 mm), the energy density of the electrode plate is prone to be reduced. By defining 0.1 mm≤S₁≤1 mm and 0.1 mm≤S₂≤1 mm, the structural strength, conductive performance, and energy density of the electrode plate are improved.

In some embodiments of this application, 0.2 mm≤S₁≤0.5 mm, and 0.2 mm≤S₂≤0.5 mm, so as to further improve the structural strength, conductive performance, and energy density of the electrode plate.

In some embodiments of this application, along the second direction, a width L₁ of the first active material layer and a width L₂ of the second active material layer satisfy: L₁>L₂. Along the first direction, a projection of the second active material layer lies within a projection of the first active material layer. A distance S₁ between the first end face and the third end face as well as a distance S₂ between the second end face and the fourth end face satisfy: 0.1 mm≤S₁≤1 mm, and 0.1 mm≤S₂≤1 mm. When S₁ or S₂ is excessively small (less than 0.1 mm), the end portions of the first active material layer and the second active material layer may be flush with each other due to the fluctuation of the processing tolerance, thereby being unable to reduce the thickness of the electrode plate at a position corresponding to the edge region of the coated section, being unfavorable to alleviating the shear force borne by the edge region of the coated section during cold-pressing, and impairing the structural strength and conductive performance of the electrode plate. When S₁ or S₂ is excessively large (greater than 1 mm), the energy density of the electrode plate is prone to be reduced. By defining 0.1 mm≤S₁≤1 mm and 0.1 mm≤S₂≤1 mm, the structural strength, conductive performance, and energy density of the electrode plate are improved.

In some embodiments of this application, 0.2 mm≤S₁≤0.5 mm, and 0.2 mm≤S₂≤0.5 mm, so as to further improve the structural strength, conductive performance, and energy density of the electrode plate.

In some embodiments of this application, S₁=(1±5%)S₂, so as to balance the force on the edge region on both sides of the coated section and increase the structural strength of the electrode plate.

In some embodiments of this application, along the first direction, the thickness H₁ of the current collector satisfies: 4 μm≤H₁≤20 μm, so as to meet the requirement on the structural strength of the current collector and reduce the space waste caused by the large footprint of the current collector, and in turn, increase the energy density of the electrode plate. A thickness H₂ of the first active material layer satisfies: 60 μm≤H₂≤160 μm; and a thickness H₃ of the second active material layer satisfies: 60 μm≤H₃≤160 μm, so as to control the internal resistance of the electrode plate and reduce the space waste caused by the first active material layer or the second active material layer, and in turn, increase the energy density of the electrode plate.

In some embodiments of this application, 8 μm≤H₁≤10 μm, so as to further meet the requirement on the structural strength of the current collector and reduce the space waste caused by the large footprint of the current collector, and in turn, increase the energy density of the electrode plate. Further, 90 μm≤H₂≤110 μm, and 90 μm≤H₃≤110 μm, so as to further control the internal resistance of the electrode plate and reduce the space waste caused by the first active material layer or the second active material layer, and in turn, increase the energy density of the electrode plate.

In some embodiments of this application, the first active material layer includes first active material particles, and a particle diameter of the first active material particles is 5 μm to 20 μm; the second active material layer includes second active material particles, and a particle diameter of the second active material particles is 5 μm to 20 μm, so as to optimize the appearance and bonding strength of the electrode plate, and improve the cycle performance, energy density, and lithium plating suppression capability of the electrode plate.

In some embodiments of this application, the particle diameter of the first active material particles is 10 μm to 15 μm, and the particle diameter of the second active material particles is 10 μm to 15 μm, so as to further optimize the appearance and bonding strength of the electrode plate, and improve the cycle performance, energy density, and lithium plating suppression capability of the electrode plate.

In some embodiments of this application, a compaction density of the first active material layer is 3 g/cm³ to 4 g/cm³, and a compaction density of the second active material layer is 3 g/cm³ to 4 g/cm³, so as to improve the energy density and cycle performance of the electrode plate.

An embodiment of this application further provides a battery cell. The battery cell includes an electrode assembly. The electrode assembly includes the electrode plate disclosed in any one of the above embodiments.

An embodiment of this application further provides an electrical device. The electrical device includes the electrode plate disclosed in any one of the above embodiments or the battery cell disclosed in any one of the above embodiments.

In the electrode plate, battery cell, and electrical device, along the first direction, a part of the projection of the first active material layer does not coincide with the projection of the second active material layer, so that only either the first active material layer or the second active material layer is disposed in the edge region, close to the first blank foil section, of the coated section; and/or, only either the first active material layer or the second active material layer is disposed in the edge region, away from the first blank foil section, of the coated section. In contrast to the conventional electrode plate in which the active material layer is disposed on both sides of the edge region of the coated section, this application can reduce the thickness of the electrode plate at a position corresponding to the edge region of the coated section, thereby alleviating the shear force borne by the edge region of the coated section during cold-pressing, reducing the risk that the structural strength and conductive performance of the current collector are impaired at the boundary of the coated section due to an excessive shear force, and in turn, improving the structural strength and conductive performance of the electrode plate.

### BRIEF DESCRIPTION OF DRAWINGS

FIG. 1 is a schematic plan view of an electrode plate according to an embodiment of this application;

FIG. 2 is a schematic plan view of an electrode plate according to another embodiment of this application;

FIG. 3 is a schematic plan view of an electrode plate according to another embodiment of this application;

FIG. 4 is a schematic plan view of an electrode plate according to another embodiment of this application;

FIG. 5 is a schematic structural diagram of a battery cell according to an embodiment of this application; and

FIG. 6 is a schematic structural diagram of an electrical device according to an embodiment of this application.

### LIST OF REFERENCE NUMERALS

electrode plate 100a, 100b, 100c, 100d
battery cell 200
electrical device 300
current collector 10
support layer 11
first conductive layer 12
second conductive layer 13
first blank foil section 10a
coated section 10b
edge region 101, 102
second blank foil section 10c
first active material layer 20
first end face 21
second end face 22
second active material layer 30
third end face 31
fourth end face 32
electrode assembly 201
first electrode plate 202
second electrode plate 203
separator 204
tab 205
first direction Z
second direction X
third direction Y

This application is further described below with reference to the following specific embodiments and the foregoing drawings.

### DETAILED DESCRIPTION

The following describes the technical solutions in the embodiments of this application with reference to the drawings hereto. Evidently, the described embodiments are merely a part of but not all of the embodiments of this application.

It is hereby noted that a component considered to be “connected to” another component may be directly connected to the other component or may be connected to the other component through an intermediate component. A component considered to be “disposed on” another component may be directly disposed on the other component or may be disposed on the other component through an intermediate component. When a value is considered to be “equal” to another value, it means that the two values are equal within a preset deviation range of 5%. In other words, when at least one of the two values fluctuates within the preset deviation range, it is still determined that the values are approximately equal even if the values are not exactly equal. When a ratio of one value to another is considered to be 1:1, it means that the two values are equal within a preset deviation range of 5%. In other words, when at least one of the two values fluctuates within the preset deviation range, it is still determined that the values are approximately equal even if the values are not exactly equal.

Unless otherwise defined, all technical and scientific terms used herein bear the same meanings as what is normally understood by a person skilled in the technical field of this application. The terms used in the specification of this application are merely intended to describe specific embodiments but not to limit this application. The term “and/or” used herein includes any and all combinations of one or more relevant items enumerated.

Understandably, considering the actual process tolerance, the term “perpendicular” or “vertical” used in the technical solutions of this application is used to describe an ideal state between two components. In the actual production or use state, one component may be approximately perpendicular to another component. For example, numerically, the term “perpendicular” may represent an angle of 90°±10° between two straight lines, or a dihedral angle of 90°±10° between two planes, or an angle of 90°±10° between a straight line and a plane. Two components described as “perpendicular” to each other may be not absolute straight lines or planes, but may be roughly straight lines or planes. An object is considered to be a “straight line” or “plane” if the overall extension direction of the object is a straight line or plane as viewed from a macro perspective.

An embodiment of this application provides an electrode plate. The electrode plate includes a current collector, a first active material layer, and a second active material layer. The current collector includes a support layer and a first conductive layer and a second conductive layer that are disposed on two sides of the support layer in a first direction respectively. The first direction is a thickness direction of the current collector. The current collector is divided into a first blank foil section and a coated section disposed in sequence in a second direction. The first blank foil section is configured to be connected to an electrode terminal, and the second direction is perpendicular to the first direction. The first active material layer is located on the coated section and disposed on a surface of the first conductive layer, the surface being oriented away from the support layer. The second active material layer is located on the coated section and disposed on a surface of the second conductive layer, the surface being oriented away from the support layer. Along the first direction, a part of a projection of the first active material layer does not coincide with a projection of the second active material layer.

In the electrode plate, along the first direction, a part of the projection of the first active material layer does not coincide with the projection of the second active material layer, so that only either the first active material layer or the second active material layer is disposed in the edge region, close to the first blank foil section, of the coated section; and/or, only either the first active material layer or the second active material layer is disposed in the edge region, away from the first blank foil section, of the coated section. In contrast to the conventional electrode plate in which the active material layer is disposed on both sides of the edge region of the coated section, this application can reduce the thickness of the electrode plate at a position corresponding to the edge region of the coated section, thereby alleviating the shear force borne by the edge region of the coated section during cold-pressing, reducing the risk that the structural strength and conductive performance of the current collector are impaired at the boundary of the coated section due to an excessive shear force, and in turn, improving the structural strength and conductive performance of the electrode plate.

The following further describes the embodiments of this application with reference to drawings.

### Embodiment 1

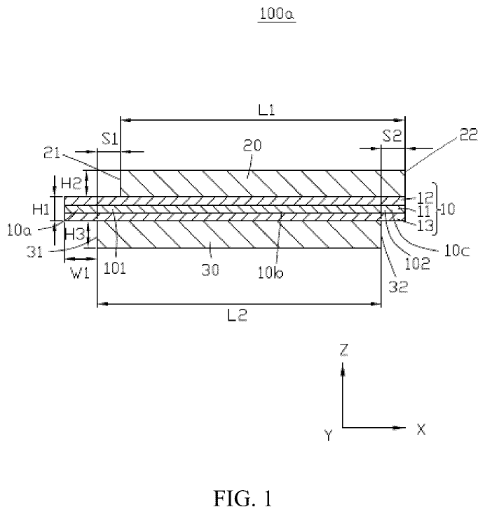

Referring to FIG. 1, an embodiment of this application provides an electrode plate 100a. The electrode plate 100a is configured to form a battery cell to be applied in a secondary battery. The secondary battery is a battery that is reusable through activation of an active material in the battery by charging the battery that is discharged. Optionally, the electrode plate 100a may be a positive electrode plate or a negative electrode plate.

The electrode plate 100a includes a current collector 10, a first active material layer 20, and a second active material layer 30. The current collector 10 is a composite current collector configured to collect an electrical current. Specifically, the current collector 10 includes a support layer 11 and a first conductive layer 12 and a second conductive layer 13 that are disposed on two sides of the support layer 11 in a first direction Z respectively. The first direction Z is a thickness direction of the current collector 10.

The support layer 11 is made of a polymer insulation material, and possesses relatively high structural strength and a relatively low density and mass, and can reduce the thickness of the current collector 10 and the weight of the current collector 10.

Optionally, the polymer insulation material includes one or more of polyethylene terephthalate (Polyethyleneterephthalate, PET), polypropylene (Polypropylene, PP), polyethylene (PE), polyimide (Polyimide, PI), polyetherketone (Polyetherketone, PEK), or polyphenylene sulphide (Polyphenylenesulphide, PPS).

The first conductive layer 12 and the second conductive layer 13 are made of a metal material. In contrast to a conventional current collector made of a metal, the thickness of the first conductive layer 12 and the second conductive layer 13 disposed on two sides of the support layer 11 is thinner, thereby reducing the generation of metal burrs when the current collector 10 is mechanically damaged by an external force impact, thereby reducing the risk of short circuits.

Optionally, the metal material includes one or more of aluminum, copper, nickel, silver, gold, or iron.

The current collector 10 is divided into a first blank foil section 10a and a coated section 10b disposed in sequence in a second direction X. The first direction Z is perpendicular to the second direction X. Optionally, the second direction X is a width direction of the current collector 10. The blank foil section means a region coated with the active material layer on neither side of the current collector. The first blank foil section 10a is configured to be connected to an electrode terminal. The electrode terminal may be, but is not limited to, a tab. The two sides of the coated section 10b in the first direction Z are configured to be connected to the first active material layer 20 and the second active material layer 30 respectively.

The first active material layer 20 is located on the coated section 10b and disposed on a surface of the first conductive layer 12, the surface being oriented away from the support layer 11. The second active material layer 30 is located on the coated section 10b and disposed on a surface of the second conductive layer 13, the surface being oriented away from the support layer 11. The first active material layer 20 and the second active material layer 30 are configured to generate an electrical current and let the current be collected on the current collector 10. Specifically, the first active material layer 20 and the second active material layer 30 are applied onto the surface of the first conductive layer 12 or the surface of the second conductive layer 13 by extrusion coating, transfer coating, spray coating, or other means.

Optionally, the first active material layer 20 is disposed continuously on the surface of the first conductive layer 12, and the second active material layer 30 is disposed continuously on the surface of the second conductive layer 13.

Along the first direction Z, a part of a projection of the first active material layer 20 does not coincide with a projection of the second active material layer 30. Specifically, a part of the projection of the first active material layer 20 does not coincide with the projection of the second active material layer 30 in the second direction X. Along the second direction X, the first active material layer 20 includes a first end face 21 and a second end face 22 disposed opposite to each other, the first end face 21 is closer to the first blank foil section 10a than the second end face 22, and the second end face 22 is farther away from the first blank foil section 10a than the first end face 21; the second active material layer 30 includes a third end face 31 and a fourth end face 32 disposed opposite to each other, the third end face 31 is closer to the first blank foil section 10a than the fourth end face 32, and the fourth end face 32 is farther away from the first blank foil section 10a than the third end face 31. At least a part of the projection of the first end face 21 in the first direction Z does not overlap with the projection of the third end face 31 in the first direction Z, and/or, at least a part of the projection of the second end face 22 in the first direction Z does not overlap with the projection of the fourth end face 32 in the first direction Z.

Understandably, when viewed along the third direction Y, the first end face 21, the second end face 22, the third end face 31, and the fourth end face 32 each may be one of a planar structure, a curved face structure, or an irregular structure. The first direction Z, the second direction X, and the third direction Y are perpendicular to each other. It is hereby noted that the shortest distance between the two end faces is used as a distance limiting the above range.

Understandably, in some other embodiments, a thinned region is further disposed at an edge position of the first active material layer 20 in the second direction X. The first end face 21 and/or the second end face 22 are located at the end portions of the corresponding thinned region. A thinned region is further disposed at an edge position of the second active material layer 30 in the second direction X. The third end face 31 and/or the fourth end face 32 are located at the end portions of the corresponding thinned region.

In the electrode plate 100a, along the first direction Z, a part of the projection of the first active material layer 20 does not coincide with the projection of the second active material layer 30, so that only either the first active material layer 20 or the second active material layer 30 is disposed in the edge region 101, close to the first blank foil section 10a, of the coated section 10b; and/or, only either the first active material layer 20 or the second active material layer 30 is disposed in the edge region 102, away from the first blank foil section 10a, of the coated section 10b. In contrast to the conventional electrode plate in which the active material layer is disposed on both sides of the edge region of the coated section, this application can reduce the thickness of the electrode plate 100a at a position corresponding to the edge region 101 (102) of the coated section 10b, thereby alleviating the shear force borne by the edge region 101 (102) of the coated section 10b during cold-pressing, reducing the risk that the structural strength and conductive performance of the current collector 10 are impaired at the boundary of the coated section 10b due to an excessive shear force, and in turn, improving the structural strength and conductive performance of the electrode plate 100a.

It is hereby noted that the boundary of the coated section 10b includes a boundary between the coated section 10b and the first blank foil section 10a as well as a boundary between the coated section 10b and the outside.

### Embodiment 2

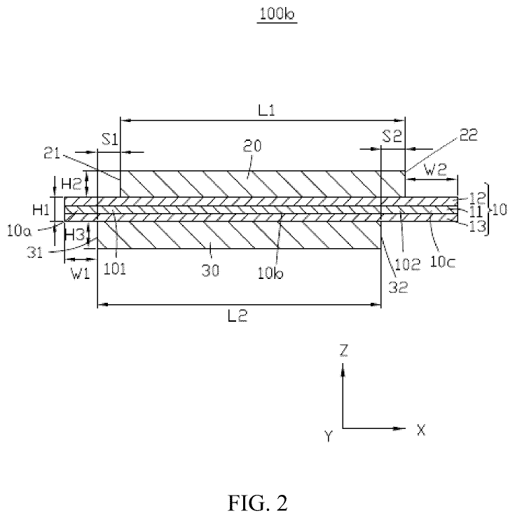

Referring to FIG. 2, an embodiment of this application further provides an electrode plate 100b. The difference between the electrode plate 100b and the electrode plate 100a is that the current collector 10 further includes a second blank foil section 10c in the second direction X, and the coated section 10b is located between the first blank foil section 10a and the second blank foil section 10c. The second blank foil section 10c is configured to be connected to the electrode terminal. Along the second direction X, the second end face 22 is closer to the second blank foil section 10c than the first end face 21. The fourth end face 32 is closer to the second blank foil section 10c than the third end face 31, and the edge region 102 of the coated section 10b is close to the second blank foil section 10c.

Still referring to FIG. 2, in some embodiments, along the second direction X, the width L₁ of the first active material layer 20 and the width L₂ of the second active material layer satisfy: L₁=(1±5%)L₂; and the distance S₁ between the first end face 21 and the third end face 31 as well as the distance S₂ between the second end face 22 and the fourth end face 32 satisfy: S₁=(1±5%)S₂, 0.1 mm≤S₁≤1 mm, and 0.1 mm≤S₂≤1 mm. When S₁ or S₂ is excessively small (less than 0.1 mm), the end portions of the first active material layer 20 and the second active material layer 30 may be flush with each other due to the fluctuation of the processing tolerance, thereby being unable to reduce the thickness of the electrode plate 100a at a position corresponding to the edge region 101 (102) of the coated section 10b, being unfavorable to alleviating the shear force borne by the edge region 101 (102) of the coated section 10b during cold-pressing, and impairing the structural strength and conductive performance of the electrode plate 100a. When S₁ and S₂ are excessively large (greater than 1 mm), the energy density of the electrode plate 100a is prone to be reduced. By defining 0.1 mm≤S₁≤1 mm and 0.1 mm≤S₂≤1 mm, the structural strength, conductive performance, and energy density of the electrode plate 100a are improved.

Optionally, S₁ may be 0.1 mm, 0.2 mm, 0.3 mm, 0.4 mm, 0.5 mm, 0.6 mm, 0.7 mm, 0.8 mm, 0.9 mm, 1 mm, or any other value falling within the range of 0.1 mm to 1 mm. S₂ may be 0.1 mm, 0.2 mm, 0.3 mm, 0.4 mm, 0.5 mm, 0.6 mm, 0.7 mm, 0.8 mm, 0.9 mm, 1 mm, or any other value falling within the range of 0.1 mm to 1 mm.

Further, 0.2 mm≤S₁≤0.5 mm and 0.2 mm≤S₂≤0.5 mm, so as to further improve the structural strength, conductive performance, and energy density of the electrode plate 100a.

Still referring to FIG. 2, in some embodiments, along the second direction X, the width W₁ of the first blank foil section 10a satisfies: 1 mm≤W₁≤5 mm, and the width W₂ of the second blank foil section 10c satisfies: 1 mm≤W₂≤5 mm. When S₁ or S₂ is excessively small (less than 1 mm), the connection region between the first blank foil section 10a or the second blank foil section 10c and the electrode terminal is prone to be relatively small, thereby resulting in relatively low connection strength. When W₁ or W₂ is excessively large (greater than 5 μm), the footprint of the first blank foil section 10a or the second blank foil section 10c is prone to be large and cause a space waste. By defining 1 mm≤W₁≤5 mm and 1 mm≤W₂≤5 mm, this application increases the connection strength between the first blank foil section 10a or the second blank foil section 10c and the electrode terminal, reduces the space waste caused by the first blank foil section 10a or the second blank foil section 10b, and increases the energy density of the electrode plate 100a.

Optionally, W₁ may be 1 mm, 1.8 mm, 1.9 mm, 2 mm, 2.1 mm, 2.2 mm, 2.3 mm, 2.4 mm, 3 mm, 4 mm, 5 mm, or any other value falling within the range of 1 mm to 5 mm. W₂ may be 1 mm, 1.8 mm, 1.9 mm, 2 mm, 2.1 mm, 2.2 mm, 2.3 mm, 2.4 mm, 3 mm, 4 mm, 5 mm, or any other value falling within the range of 1 mm to 5 mm.

Further, 1.8 mm≤W₁≤2.4 mm, and 1.8 mm≤W₂≤2.4 mm, so as to further increase the connection strength between the first blank foil section 10a or the second blank foil section 10c and the electrode terminal, reduces the space waste caused by the first blank foil section 10a or the second blank foil section 10b, and increases the energy density of the electrode plate 100a.

In some embodiments, W₁=(1±5%)W₂, so that the forces borne on both sides of the current collector 10 are uniform, the structural strength of the electrode plate 100a is increased, and the conductive performance is balanced between two ends of the current collector 10.

Still referring to FIG. 2, in some embodiments, along the first direction Z, the thickness H₁ of the current collector 10 satisfies: 4 μm≤H₁≤20 μm, so as to meet the requirement on the structural strength of the current collector 10 and reduce the space waste caused by the large footprint of the current collector 10, and in turn, increase the energy density of the electrode plate 100a.

Optionally, H₁ may be 4 μm, 5 μm, 6 μm, 7 μm, 8 μm, 9μ, 10 μm, 11 μm, 12 μm, 13 μm, 14 μm, 15 μm, 16 μm, 17 μm, 18 μm, 19 μm, 20 μm, or any other value falling within the range of 4 μm to 20 μm.

Further, 8 μm≤H₁≤10 μm, so as to further meet the requirement on the structural strength of the current collector 10 and reduce the space waste caused by the large footprint of the current collector 10, and in turn, increase the energy density of the electrode plate 100a.

In some embodiments, along the first direction Z, the thickness H₂ of the first active material layer 20 satisfies: 60 μm≤H₂≤160 μm; and the thickness H₃ of the second active material layer 30 satisfies: 60 μm≤H₃≤160 μm. When H₂ or H₃ is excessively small (less than 60 μm), the energy density of the electrode plate 100a is prone to be excessively low. When H₂ or H₃ is excessively large (greater than 160 μm), the internal resistance of the electrode plate 100a is prone to increase, and the footprint of the first active material layer 20 or the second active material layer 30 is prone to be large and cause a space waste. By defining 60 μm≤H₂≤160 μm and 60 μm≤H₃≤160 μm, this application controls the internal resistance of the electrode plate 100a and reduces the space waste caused by the first active material layer 20 or the second active material layer 30, and in turn, increases the energy density of the electrode plate 100a.

Optionally, H₂ may be 60 μm, 65 μm, 70 μm, 75 μm, 80 μm, 85 μm, 90 μm, 95 μm, 100 μm, 105 μm, 110 μm, 115 μm, 120 μm, 125 μm, 130 μm, 135 μm, 140 μm, 145 μm, 150 μm, 155 μm, 160 μm, or any other value falling within the range of 60 μm to 160 μm. H₃ may be 60 μm, 65 μm, 70 μm, 75 μm, 80 μm, 85 μm, 90 μm, 95 μm, 100 μm, 105 μm, 110 μm, 115 μm, 120 μm, 125 μm, 130 μm, 135 μm, 140 μm, 145 μm, 150 μm, 155 μm, 160 μm, or any other value falling within the range of 60 μm to 160 μm.

Further, 90 μm≤H₂≤110 μm and 90 μm≤H₃≤110 μm, so as to further control the internal resistance of the electrode plate 100a and reduce the space waste caused by the first active material layer 20 or the second active material layer 30, and in turn, increase the energy density of the electrode plate 100a.

In some embodiments, H₂=(1±5%)H₃, so as to uniformize the forces borne on two sides of the current collector 10, and improve the structural stability and reliability of the electrode plate 100a.

In some embodiments, the coating weight of the first active material layer 20 is 100 mg/1540.25 mm² to 400 mg/1540.25 mm²; and the coating weight of the second active material layer 30 is 100 mg/1540.25 mm² to 400 mg/1540.25 mm². When the coating weight is excessively small (less than 100 mg/1540.25 mm²), the energy density of the electrode plate 100a is prone to be excessively low. When the coating weight is excessively large (greater than 400 mg/1540.25 mm²), a waste of the slurry is prone to occur, or even worse, an excessive capacity may occur, and dendrites may be precipitated and pierce the separator to cause a short circuit, thereby impairing the safety of the battery cell containing the electrode plate 100a. By defining the coating weight of the first active material layer 20 to be 100 mg/1540.25 mm² to 400 mg/1540.25 mm² and the coating weight of the second active material layer 30 to be 100 mg/1540.25 mm² to 400 mg/1540.25 mm², this application increases the energy density of the electrode plate 100a, reduce the waste of the slurry, and improve the safety of the battery cell containing the electrode plate 100a.

Optionally, the value of the coating weight of the first active material layer 20 may be 100, 110, 120, 130, 140, 150, 160, 170, 180, 190, 200, 210, 220, 230, 240, 250, 260, 270, 280, 290, 300, 310, 320, 330, 340, 350, 360, 370, 380, 390, 400, or any other value falling within the range of 100 to 400. The unit of the corresponding coating weight is mg/1540.25 mm². The value of the coating weight of the second active material layer 30 may be 100, 110, 120, 130, 140, 150, 160, 170, 180, 190, 200, 210, 220, 230, 240, 250, 260, 270, 280, 290, 300, 310, 320, 330, 340, 350, 360, 370, 380, 390, 400, or any other value falling within the range of 100 to 400. The unit of the corresponding coating weight is mg/1540.25 mm².

In some embodiments, the first active material layer 20 includes first active material particles. A particle diameter of the first active material particles is 5 μm to 20 μm. The second active material layer 30 includes second active material particles. A particle diameter of the second active material particles is 5 μm to 20 μm. When the particle diameter is excessively small (less than 5 μm), the slurry is hardly dispersible, causes an adverse effect on the appearance and bonding strength of the electrode plate 100a, and in turn, impairs the cycle performance of the electrode plate 100a. When the particle diameter is excessively large (greater than 20 μm), the solid-phase diffusion resistance of the active ions is prone to increase, and the polarization is prone to intensify, thereby impairing the energy density and lithium plating suppression capability of the electrode plate 100a. By defining the particle diameter of the first active material particles to be 5 μm to 20 μm, this application optimizes the appearance and bonding strength of the electrode plate 100a, and improves the cycle performance, energy density, and lithium plating suppression capability of the electrode plate 100a. Optionally, the particle diameter of the first active material particles is 5 μm, 6 μm, 7 μm, 8 μm, 9 μm, 10 μm, 11 μm, 12 μm, 13 μm, 14 μm, 15 μm, 16 μm, 17 μm, 18 μm, 19 μm, 20 μm, or any other value falling within the range of 5 μm to 20 μm. Optionally, the particle diameter of the second active material particles is 5 μm, 6 μm, 7 μm, 8 μm, 9 μm, 10 μm, 11 μm, 12 μm, 13 μm, 14 μm, 15 μm, 16 μm, 17 μm, 18 μm, 19 μm, 20 μm, or any other value falling within the range of 5 μm to 20 μm.

Further, the particle diameter of the first active material particles is 10 μm to 15 μm, and the particle diameter of the second active material particles is 10 μm to 15 μm, so as to further optimize the appearance and bonding strength of the electrode plate 100a, and improve the cycle performance, energy density, and lithium plating suppression capability of the electrode plate 100a.

In some embodiments, a compaction density of the first active material layer 20 is 3 g/cm³ to 4 g/cm³, and a compaction density of the second active material layer 30 is 3 g/cm³ to 4 g/cm³. When the compaction density is excessively small (less than 3 g/cm³), the energy density of the electrode plate 100a is prone to be deficient; when the compaction density is excessively large (greater than 4 g/cm³), the ion transmission channel is prone to be reduced and impair the cycle performance of the electrode plate 100a. By defining the compaction density of the first active material layer 20 to be 3 g/cm³ to 4 g/cm³ and the compaction density of the second active material layer 30 to be 3 g/cm³ to 4 g/cm³, this application improves the energy density and cycle performance of the electrode plate 100a.

Optionally, the compaction density of the first active material layer 20 may be 3 g/cm³, 3.1 g/cm³, 3.2 g/cm³, 3.3 g/cm³, 3.4 g/cm³, 3.5 g/cm³, 3.6 g/cm³, 3.7 g/cm³, 3.8 g/cm³, 3.9 g/cm³, 4 g/cm³, or any other value falling within the range of 3 g/cm³ to 4 g/cm³.

Understandably, in some other embodiments, the electrode plate further includes a transition layer. The transition layer is disposed between the first active material layer 20 and the first conductive layer 12; and/or, the transition layer is disposed between the second active material layer 30 and the second conductive layer 13. The current generated by the first active material layer 20 and the second active material layer 30 is collected on the current collector 10 through the corresponding transition layer. The transition layer is configured to increase the connection strength between the first active material layer 20, the second active material layer 30, and the current collector 10, and reduce the risk that the sharp part in the first active material layer 20 or the second active material layer 30 pierces the first conductive layer 12 or the second conductive layer 13.

It is hereby noted that the parameters of the electrode plate 100b and the electrode plate 100a are substantially the same except the above differences, and may be learned with reference to the description of the above electrode plate 100a.

### Embodiment 3

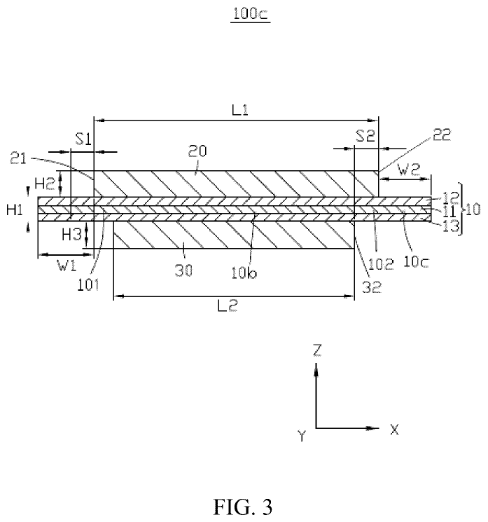

Referring to FIG. 3, an embodiment of this application further provides an electrode plate 100c. The electrode plate 100c differs from the electrode plate 100b in that, along the second direction X, the width L₁ of the first active material layer 20 and the width L₂ of the second active material layer 30 satisfy: L₁>L₂. Along the first direction Z, the projection of the second active material layer 30 lies within the projection of the first active material layer 20. The distance S₁ between the first end face 21 and the third end face 31 as well as the distance S₂ between the second end face 22 and the fourth end face 32 satisfy: 0.1 mm≤S₁≤1 mm, and 0.1 mm≤S₂≤1 mm. When S₁ or S₂ is excessively small (less than 0.1 mm), the end portions of the first active material layer 20 and the second active material layer 30 may be flush with each other due to the fluctuation of the processing tolerance, thereby being unable to reduce the thickness of the electrode plate 100a at a position corresponding to the edge region 101 (102) of the coated section 10b, being unfavorable to alleviating the shear force borne by the edge region 101 (102) of the coated section 10b during cold-pressing, and impairing the structural strength and conductive performance of the electrode plate 100a. When S₁ and S₂ are excessively large (greater than 1 mm), the energy density of the electrode plate 100a is prone to be reduced. By defining 0.1 mm≤S₁≤1 mm and 0.1 mm≤S₂≤1 mm, the structural strength, conductive performance, and energy density of the electrode plate 100a are improved.

Optionally, S₁ may be 0.1 mm, 0.2 mm, 0.3 mm, 0.4 mm, 0.5 mm, 0.6 mm, 0.7 mm, 0.8 mm, 0.9 mm, 1 mm, or any other value falling within the range of 0.1 mm to 1 mm. S₂ may be 0.1 mm, 0.2 mm, 0.3 mm, 0.4 mm, 0.5 mm, 0.6 mm, 0.7 mm, 0.8 mm, 0.9 mm, 1 mm, or any other value falling within the range of 0.1 mm to 1 mm.

Further, 0.2 mm≤S₁≤0.5 mm and 0.2 mm≤S₂≤0.5 mm, so as to further improve the structural strength, conductive performance, and energy density of the electrode plate 100a.

In some embodiments, S₁=(1±5%)S₂, so as to balance the force on the edge region 101 (102) on both sides of the coated section 10b and increase the structural strength of the electrode plate 100b.

It is hereby noted that the parameters of the electrode plate 100c and the electrode plate 100b are substantially the same except the above differences, and may be learned with reference to the description of the above electrode plate 100b.

### Embodiment 4

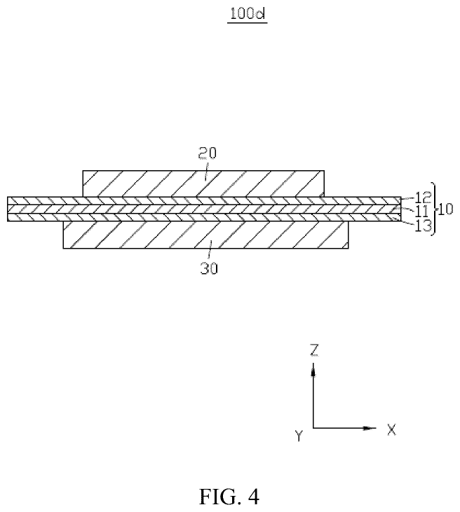

Referring to FIG. 4, understandably, an embodiment of this application further provides an electrode plate 100d. The electrode plate 100d differs from the electrode plate 100c in that, along the second direction X, the width L₁ of the first active material layer 20 and the width L₂ of the second active material layer 30 satisfy: L₁<L₂. Along the first direction Z, the projection of the first active material layer 20 lies within the projection of the second active material layer 30. The distance S₁ between the first end face 21 and the third end face 31 as well as the distance S₂ between the second end face 22 and the fourth end face 32 satisfy: 0.1 mm≤S₁≤1 mm, and 0.1 mm≤S₂≤0.1 mm.

It is hereby noted that the parameters of the electrode plate 100d and the electrode plate 100c are substantially the same except the above differences, and may be learned with reference to the description of the above electrode plate 100c.

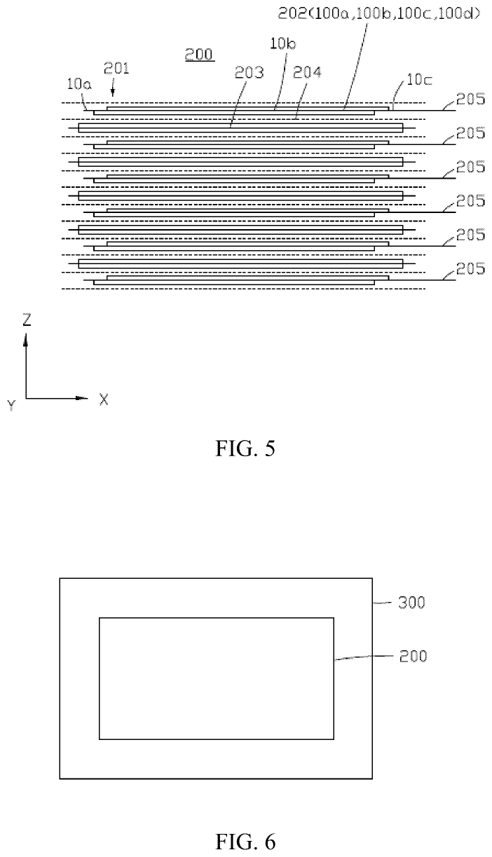

Referring to FIG. 5, an embodiment of this application further provides a battery cell 200. The battery cell includes an electrode assembly 201. The electrode assembly 201 includes the electrode plate 100a (100b, 100c, 100d) disclosed in any one of the above embodiments.

In some embodiments, the electrode assembly 201 includes a first electrode plate 202, a separator 204, and a second electrode plate 203 stacked in sequence along the first direction Z. The first electrode plate 202 is of a positive polarity, and the second electrode plate 203 is of a negative polarity. At least one of the first electrode plate 202 or the second electrode plate 203 is the electrode plate 100a (100b, 100c, 100d).

In some embodiments, the first electrode plate 202 is the electrode plate 100a (100b, 100c, 100d), and the battery cell 200 further includes a plurality of tabs 205. One end of each tab 205 is connected to the first blank foil section 10a or the second blank foil section 10c of the first electrode plate 202, and the other end of each tab 205 extends outward.

Understandably, in some other embodiments, the electrode assembly 201 includes a first electrode plate 202, a separator 204, and a second electrode plate 203 that are wound in sequence. The first electrode plate 202 is of a positive polarity, and the second electrode plate 203 is of a negative polarity. At least one of the first electrode plate 202 or the second electrode plate 203 is the electrode plate 100a (100b, 100c, 100d).

Referring to FIG. 6, an embodiment of this application further provides an electrical device 300. The electrical device includes the electrode plate 100a (100b, 100c, 100d) disclosed in any one of the above embodiments or the battery cell 200 disclosed in any one of the above embodiments. The electrical device 300 may be a vehicle, a mobile phone, a portable device, a notebook computer, a ship, a spacecraft, an electric toy, a power tool, or the like.

To sum up, in the electrode plate 100a (100b, 100c, 100d), the battery cell 200, and the electrical device 300, along the first direction Z, a part of the projection of the first active material layer 20 does not coincide with the projection of the second active material layer 30, so that only either the first active material layer 20 or the second active material layer 30 is disposed in the edge region 101, close to the first blank foil section 10a, of the coated section 10b; and/or, only either the first active material layer 20 or the second active material layer 30 is disposed in the edge region 102, away from the first blank foil section 10a, of the coated section 10b. In contrast to the conventional electrode plate in which the active material layer is disposed on both sides of the edge region of the coated section, this application can reduce the thickness of the electrode plate 100a at a position corresponding to the edge region 101 (102) of the coated section 10b, thereby alleviating the shear force borne by the edge region 101 (102) of the coated section 10b during cold-pressing, reducing the risk that the structural strength and conductive performance of the current collector 10 are impaired at the boundary of the coated section 10b due to an excessive shear force, and in turn, improving the structural strength and conductive performance of the electrode plate 100a.

In addition, a person skilled in the art may make other variations to this application without departing from the essence of this application. The variations made based on the essence of this application still fall within the protection scope of this application.

What is claimed is:

1. An electrode plate, comprising:
a current collector, wherein the current collector comprises a support layer, a first conductive layer, and a second conductive layer; the first conductive layer and the second conductive layer are disposed on two sides of the support layer in a first direction respectively, the first direction is a thickness direction of the current collector, the current collector is divided into a first blank foil section and a coated section disposed in sequence in a second direction, the first blank foil section is configured to be connected to an electrode terminal, and the second direction is perpendicular to the first direction;
a first active material layer, located on the coated section and disposed on a surface of the first conductive layer, the surface of the first conductive layer being oriented away from the support layer;
a second active material layer, located on the coated section and disposed on a surface of the second conductive layer, the surface of the second conductive layer being oriented away from the support layer; and
along the first direction, a part of a projection of the first active material layer does not coincide with a projection of the second active material layer.

2. The electrode plate according to claim 1, wherein the current collector further comprises a second blank foil section in the second direction, and the coated section is located between the first blank foil section and the second blank foil section; along the second direction, the first active material layer comprises a first end face and a second end face disposed opposite to each other, the first end face is closer to the first blank foil section than the second end face, and the second end face is closer to the second blank foil section than the first end face;
along the second direction, the second active material layer comprises a third end face and a fourth end face disposed opposite to each other, the third end face is closer to the first blank foil section than the fourth end face, and the fourth end face is closer to the second blank foil section than the third end face; and
at least a part of a projection of the first end face in the first direction does not overlap with a projection of the third end face in the first direction, and/or at least a part of a projection of the second end face in the first direction does not overlap with a projection of the fourth end face in the first direction.

3. The electrode plate according to claim 2, wherein, along the second direction, a width W₁ of the first blank foil section satisfies: 1 mm≤W₁≤5 mm, and a width W₂ of the second blank foil section satisfies: 1 mm≤W₂≤5 mm.

4. The electrode plate according to claim 3, wherein 1.8 mm≤W₁≤2.4 mm, and 1.8 mm≤W₂≤2.4 mm.

5. The electrode plate according to claim 2, wherein, along the second direction, a width L₁ of the first active material layer and a width L₂ of the second active material layer satisfy: L₁=(1±5%)L₂; a distance S₁ between the first end face and the third end face, and a distance S₂ between the second end face and the fourth end face satisfy: S₁=(1±5%)S₂, 0.1 mm≤S₁≤1 mm, and 0.1 mm≤S₂≤1 mm.

6. The electrode plate according to claim 5, wherein 0.2 mm≤S₁≤0.5 mm, and 0.2 mm≤S₂≤0.5 mm.

7. The electrode plate according to claim 2, wherein, along the second direction, a width L₁ of the first active material layer and a width L₂ of the second active material layer satisfy: L₁>L₂; along the first direction, a projection of the second active material layer lies within a projection of the first active material layer; a distance S₁ between the first end face and the third end face, and a distance S₂ between the second end face and the fourth end face satisfy: 0.1 mm≤S₁≤1 mm, and 0.1 mm≤S₂≤1 mm.

8. The electrode plate according to claim 7, wherein 0.2 mm≤S₁≤0.5 mm, and 0.2 mm≤S₂≤0.5 mm.

9. The electrode plate according to claim 8, wherein S₁=(1±5%)S₂.

10. The electrode plate according to claim 1, wherein, along the first direction, a thickness H₁ of the current collector satisfies: 4 μm≤H₁≤20 μm; a thickness H₂ of the first active material layer satisfies: 60 μm≤H₂≤160 μm; and a thickness H₃ of the second active material layer satisfies: 60 μm≤H₃≤160 μm.

11. The electrode plate according to claim 2, wherein, along the first direction, a thickness H₁ of the current collector satisfies: 4 μm≤H₁≤20 μm; a thickness H₂ of the first active material layer satisfies: 60 μm≤H₂≤160 μm; and a thickness H₃ of the second active material layer satisfies: 60 μm≤H₃≤160 μm.

12. The electrode plate according to claim 3, wherein, along the first direction, a thickness H₁ of the current collector satisfies: 4 μm≤H₁≤20 μm; a thickness H₂ of the first active material layer satisfies: 60 μm≤H₂≤160 μm; and a thickness H₃ of the second active material layer satisfies: 60 μm≤H₃≤160 μm.

13. The electrode plate according to claim 4, wherein, along the first direction, a thickness H₁ of the current collector satisfies: 4 μm≤H₁≤20 μm; a thickness H₂ of the first active material layer satisfies: 60 μm≤H₂≤160 μm; and a thickness H₃ of the second active material layer satisfies: 60 μm≤H₃≤160 μm.

14. The electrode plate according to claim 10, wherein 8 μm≤H₁≤10 μm, 90 μm≤H₂≤110 μm, and 90 μm≤H₃≤110 μm.

15. The electrode plate according to claim 1, wherein the first active material layer comprises first active material particles, and a particle diameter of each first active material particle is in a range of 5 μm to 20 μm, the second active material layer comprises second active material particles, and a particle diameter of each second active material particle is in a range of 5 μm to 20 μm.

16. The electrode plate according to claim 15, wherein the particle diameter of the each first active material particle is in a range of 10 μm to 15 μm, and the particle diameter of the each second active material particles is in a range of 10 μm to 15 μm.

17. The electrode plate according to claim 1, wherein a compaction density of the first active material layer is 3 g/cm³ to 4 g/cm³, and a compaction density of the second active material layer is 3 g/cm³ to 4 g/cm³.

18. A battery cell, wherein the battery cell comprises an electrode assembly, and the electrode assembly comprises the electrode plate according to claim 1.

19. An electrical device, wherein the electrical device comprises the battery cell according to claim 18.
